(19) United States
(12) Patent Application Publication
(10) Pub. No.: US 2026/0211813 A1
(43) Pub. Date: Jul. 23, 2026

(54) METHOD FOR PROCESSING USER QUERY, ELECTRONIC DEVICE AND STORAGE MEDIUM

(71) Applicant: BEIJING BAIDU NETCOM SCIENCE TECHNOLOGY CO., LTD., Beijing (CN)

(72) Inventors: Jian CHEN, Beijing (CN); Zhenyu LI, Beijing (CN); Jiajun JIANG, Beijing (CN); Kaipeng DENG, Beijing (CN); Qingqing DANG, Beijing (CN); Yanlin SHA, Beijing (CN); Zeyu CHEN, Beijing (CN); Dianhai YU, Beijing (CN); Yanjun MA, Beijing (CN)

(73) Assignee: BEIJING BAIDU NETCOM SCIENCE TECHNOLOGY CO., LTD., Beijing (CN)

(21) Appl. No.: 19/569,631

(22) Filed: Mar. 17, 2026

(30) Foreign Application Priority Data
May 6, 2025 (CN) 202510579211.3

(51) Int. Cl. G06F 12/0802; G06F 40/284

(52) U.S. Cl. CPC G06F 12/0802; G06F 40/284

(57) ABSTRACT

Provided is a method for processing a user query, an electronic device and a storage medium, relating to the field of computer technology, and in particular to the fields of artificial intelligence, large language model and other technologies. The method includes: receiving a first user query; performing word segmentation on the first user query to obtain a token list corresponding to the first user query; determining a reusable key-value cache of the first user query according to the token list; and when the reusable key-value cache is in a process of transmission from a GPU to a CPU, stopping the transmission of the reusable key-value cache, and allocating the reusable key-value cache to the first user query.

### CROSS-REFERENCE TO RELATED APPLICATIONS

The present application claims priority to Chinese Patent Application No. CN202510579211.3, filed with the China National Intellectual Property Administration on May 6, 2025, the disclosure of which is hereby incorporated herein by reference in its entirety.

### TECHNICAL FIELD

The present disclosure relates to the field of computer technology, and in particular to the fields of artificial intelligence, large language model and other technologies.

### BACKGROUND

With the large-scale application of Large Language Models (LLMs) based on Transformer architecture, improving the service efficiency of LLMs is of vital importance. The context caching technology is an effective way to improve the service efficiency of LLMs. When a large model service system processes user queries, the system uses the context caching technology to store Key-Value Caches (KV Caches) of the processed user queries, so that these stored key-value caches can be reused directly without having to be recalculated when a new query with the same prefix comes in, thereby shortening the response time to the user query and accelerating inference. The key-value caches are stored in various storage media, such as Graphics Processing Unit (GPU) (e.g., GPU High Bandwidth Memory (HBM)), Central Processing Unit (CPU) (e.g., memory), Solid State Disk (SSD), etc. When the large model makes inference, the key-value caches are read and written directly from the GPU; when the key-value caches are hit in the CPU or SSD, the key-value caches need to be transmitted across media to the GPU. In the aforementioned process, the method for transmitting and scheduling the KV Caches directly affects the processing efficiency of the large model service system for user queries.

### SUMMARY

The present disclosure provides a method for processing a user query, a large model service system, a device and a storage medium.

According to one aspect of the present disclosure, provided is a method for processing a user query, including:
receiving a first user query;
performing word segmentation on the first user query to obtain a token list corresponding to the first user query;
determining a reusable key-value cache of the first user query according to the token list; and
when the reusable key-value cache is in a process of transmission from a GPU to a CPU, stopping the transmission of the reusable key-value cache, and allocating the reusable key-value cache to the first user query.

According to another aspect of the present disclosure, provided is a large model service system, including:
a service layer configured to: receive a first user query; and perform word segmentation on the first user query to obtain a token list corresponding to the first user query; and
a key-value cache management layer configured to: determine a reusable key-value cache of the first user query according to the token list; and when the reusable key-value cache is in a process of transmission from a GPU to a CPU, stop the transmission of the reusable key-value cache, and allocate the reusable key-value cache to the first user query.

According to yet another aspect of the present disclosure, provided is an electronic device, including:
at least one processor; and
a memory connected in communication with the at least one processor;
where the memory stores an instruction executable by the at least one processor, and the instruction, when executed by the at least one processor, enables the at least one processor to execute the method of any embodiment of the present disclosure.

According to yet another aspect of the present disclosure, provided is a non-transitory computer-readable storage medium storing a computer instruction thereon, and the computer instruction is used to cause a computer to execute the method according to any one of the embodiments of the present disclosure.

According to yet another aspect of the present disclosure, provided is a computer program product including a computer program, and the computer program implements the method according to any one of the embodiments of the present disclosure, when executed by a processor.

It should be understood that the content described in this part is not intended to identify critical or essential features of embodiments of the present disclosure, nor is it used to limit the scope of the present disclosure. Other features of the present disclosure will be easily understood through the following description.

### BRIEF DESCRIPTION OF THE DRAWINGS

The accompanying drawings are used to better understand the present solution, and do not constitute a limitation to the present disclosure.

FIG. 1 is a schematic diagram of an application scenario according to an embodiment of the present disclosure;

FIG. 2 is a flowchart of an implementation of a method for processing a user query according to an embodiment of the present disclosure;

FIG. 3 is a schematic diagram of the allocation process and eviction process of KV Caches according to an embodiment of the present disclosure;

FIG. 4 is a schematic diagram of the overall framework of a large model service system according to an embodiment of the present disclosure;

FIG. 5 is a schematic diagram of a prefix tree according to an embodiment of the present disclosure;

FIG. 6 is a schematic diagram of the processing timing of the user query according to an embodiment of the present disclosure;

FIG. 7 is a schematic diagram of a process of allocating Cache Blocks according to an embodiment of the present disclosure;

FIG. 8 is a schematic diagram of a process of releasing Cache Blocks according to an embodiment of the present disclosure;

FIG. 9 is a schematic diagram of a process of evicting Cache Blocks according to an embodiment of the present disclosure;

FIG. 10 is a structural schematic diagram of a large model service system 1000 according to an embodiment of the present disclosure;

FIG. 11 is a structural schematic diagram of a large model service system 1100 according to an embodiment of the present disclosure; and

FIG. 12 shows a schematic block diagram of an exemplary electronic device 1200 that may be used to implement the embodiments of the present disclosure.

### DETAILED DESCRIPTION

Hereinafter, descriptions to exemplary embodiments of the present disclosure are made with reference to the accompanying drawings, include various details of the embodiments of the present disclosure to facilitate understanding, and should be considered as merely exemplary. Therefore, those having ordinary skill in the art should realize, various changes and modifications may be made to the embodiments described herein, without departing from the scope of the present disclosure. Likewise, for clarity and conciseness, descriptions of well-known functions and structures are omitted in the following descriptions.

The term “and/or” in the embodiments of the present disclosure indicates that there may be three relationships, for example, A and/or B may represent: only A, both A and B, and only B. The term “at least one” herein indicates any one of many items, or any combination of at least two of the many items, for example, at least one of A, B or C may indicate any one or more elements selected from a set of A, B and C. The terms “first” and “second” herein indicate a plurality of similar technical terms and distinguish them from each other, but do not limit an order of them or limit that there are only two items, for example, a first feature and a second feature indicate two types of features/two features, a quantity of the first feature may be one or more, and a quantity of the second feature may also be one or more.

The prior art related to the embodiments of the present disclosure will be introduced below. The following content is only used to assist in understanding the technical solution of the present disclosure and is not intended to limit the technical content of the embodiments of the present disclosure.

### I. Context Caching Technology

With the large-scale application of LLMs based on Transformer architecture, improving the service efficiency of LLMs is of vital importance. The context caching technology is an effective way to improve the service efficiency of LLMs.

The basic principle of the context caching technology is: the large model service system pre-stores a large amount of data or information that may be frequently requested; and then, when a user queries the same information again, the system can quickly provide the information directly from the cache without recalculating or retrieving from the original data source, thereby saving time and resources and speeding up the inference speed of the model.

For example, when the large model service system processes user queries, the system uses the context caching technology to store Key-Value Caches (KV Caches, or simply Caches) of the processed user queries, so that these stored key-value caches can be reused directly without having to be recalculated when a new query with the same prefix comes in, thereby shortening the response time to the user query and reducing the latency of the large model service system when processing the user query. In scenarios with fixed prompt templates, system settings and multi-turn dialogues, since there is a lot of repetitive content in different user queries, the use of the context caching technology can significantly accelerate inference.

In the large model service system that accelerates inference based on the context caching technology, improving the system performance mainly faces the following challenges:

Key-value caches may be stored in various storage media, such as GPU HBM, CPU memory and SSD. The read/write performance of these three media ranges from high to low, and the capacities thereof range from small to large. The storage medium has a limited capacity. When the GPU HBM is fully filled with key-value caches, the key-value caches need to be moved to the CPU memory; when the CPU memory is full, the key-value caches need to be moved to the SSD. When the GPU infers a user query, the key-value cache is directly read and written from the GPU HBM. When the key-value cache is hit in the CPU memory and SSD, the key-value cache needs to be scheduled first and then transmitted across media (i.e. from CPU to GPU) to the GPU HBM. How to improve the scheduling and transmission efficiency of key-value caches across different storage media is a crucial factor affecting the processing speed of user queries.

### II. Paged Attention Technology

The Paged Attention technology manages the storage of key-value caches corresponding to a token list, and divides the key-value caches corresponding to the token list into key-value cache blocks (KV Cache blocks, or simply Cache blocks or Blocks). A Cache block is the smallest storage unit of Cache, and each Cache contains Cache corresponding to a fixed number of tokens. For example, a Cache block typically corresponds to 64 tokens.

### III. Context Caching Technology for Cache Management Based on Paged Attention Technology

The management of Cache storage is performed based on the Paged Attention technology with Cache Block as the smallest unit of Cache storage. The acceleration of context caching is typically divided into three steps:
Step 1: divide an input token list in unit of Cache block, and match reusable Cache blocks based on hash values.
Step 2: the scheduling module determines the Cache blocks to be swapped from the CPU memory to the GPU and the Cache blocks to be swapped from the GPU to the CPU memory, initiates Cache block-by-Cache block transmission, and synchronously waits for completion of the Cache block transmission.
Step 3: the inference engine executes the next inference process.

The above process has the following drawbacks:
(1) Low Cache scheduling efficiency: when the transmission of a large number of Cache Blocks is initiated, the time for synchronously waiting for Cache Blocks to be swapped out is relatively long, affecting the rate at which the service system processes new queries and thus affecting throughput.
(2) Low Cache transmission efficiency: since the service system manages Caches in unit of Cache Block, the cross-media transmission in the existing system is Cache Block-by-Cache Block transmission. Because one Cache Block contains a small amount of Cache, the Cache Block-by-Cache Block transmission cannot fully utilize bandwidth, resulting in a very low transmission rate.

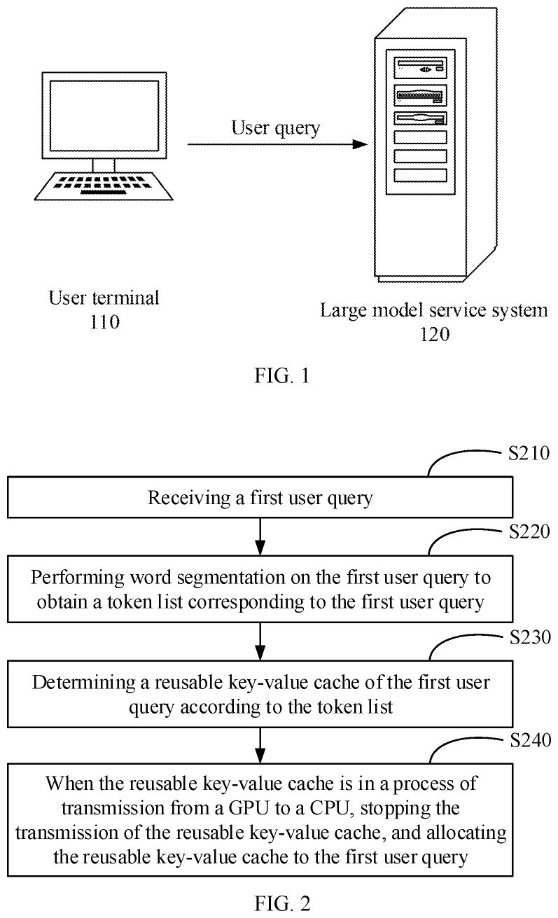

The above-mentioned drawbacks result in the low efficiency of the large model service system when processing user queries. To address the problem of low efficiency in processing user queries, the embodiments of the present disclosure propose a method for processing a user query and a large model service system. FIG. 1 is a schematic diagram of an application scenario according to an embodiment of the present disclosure. As shown in FIG. 1, the schematic diagram of the application scenario in the embodiment of the present disclosure may include, but is not limited to, a user terminal 110 and a large model service system 120. The user terminal 110 and the large model service system 120 can communicate with each other through any type of wired or wireless network. Specifically, the user terminal 110 may be used to receive a query (which may be a prompt) input by a user to a large model, and send the user query to the large model service system 120; and the large model service system 120 may be used to receive and process the user query. In the processing process, the large model service system needs to generate corresponding KV Caches for the token list of the user query; if a reusable KV Cache already exists in the system, the reusable KV Cache is allocated to the user query; for a non-reusable KV Cache, a new KV Cache is generated and allocated for the user. In the inference process for the user query, the large model service system uses both the reusable and non-reusable KV Caches of the user query for inference, thereby realizing the processing of the user query. Here, the user terminal 110 proposed in the embodiment of the present disclosure includes, but is not limited to, a mobile phone, a computer, a smart voice interaction device, a smart home appliance, a vehicle-carried terminal, a game console, an e-book reader, a multimedia playback device, a wearable device and other electronic devices; and the large model service system 120 may include a device or server for providing artificial intelligence services to the user terminal 110. Furthermore, the embodiment of the present disclosure does not impose a specific limit on the number of user terminals 110. For example, the schematic diagram of the application scenario in the embodiment of the present disclosure may include one or more user terminals 110.

FIG. 2 is a flowchart of an implementation of a method for processing a user query according to an embodiment of the present disclosure, including:
S210: receiving a first user query;
S220: performing word segmentation on the first user query to obtain a token list corresponding to the first user query;
S230: determining a reusable key-value cache (KV Cache) of the first user query according to the token list; and
S240: when the reusable key-value cache is in a process of transmission from a GPU to a CPU, stopping the transmission of the reusable key-value cache, and allocating the reusable key-value cache to the first user query.

In step S240, in some implementations, the resource on the CPU may be directly recycled, thereby stopping the transmission of the reusable key-value cache.

The method for processing the user query proposed in the embodiment of the present disclosure can be applied to a large model service system. In this method, the first user query may be any user query such as a prompt sent by a user through a terminal device; and the large model service system can respond to and process the first user query. After receiving the first user query, the large model service system first allocates a KV Cache for the token list of the first user query. If a reusable KV Cache that has been previously calculated exists, then the reusable KV Cache is allocated to the first user query.

When the large model performs inference on the first user query, there is a need to read and write the KV Caches (including reusable and non-reusable KV Caches) of the first user query from the GPU. Here, there may be several cases for the reusable KV Cache: (1) the KV Cache is in the process of transmission from the GPU to the CPU; (2) the KV Cache is stored in the CPU; (3) the KV Cache is stored in the GPU.

The method for processing the user query proposed in the embodiment of the present disclosure is mainly aimed at the first case mentioned above, that is, the reusable KV Cache allocated to the first user query is in the process of transmission from the GPU to the CPU. This case occurs because the large model allocated the KV Cache for another user query when processing the another user query, and then initiated an eviction process (i.e., transmission from the GPU to the CPU) for the KV Cache after completing the inference for the another user query. In this case, when the first user query is received and the KV Cache currently undergoing eviction can be reused for the first user query, the method proposed in the embodiment of the present disclosure eliminates the need to wait for the eviction process of the reusable KV Cache to complete before transmission from the CPU to the GPU; instead, the transmission of the reusable KV Cache can be stopped, that is, the reusable KV Cache is still stored in the GPU for use by the large model when inferring the first user query, increasing the scheduling efficiency of the KV Cache and thus improving the processing efficiency of the user query.

Furthermore, in the second case mentioned above, where the reusable KV Cache allocated for the first user query is currently stored in the CPU, the reusable KV Cache may be transmitted to the GPU for use by the large model when inferring the first user query.

In one example, the method for processing the user query proposed in the embodiment of the present disclosure further includes:
when the reusable KV Cache is stored in the CPU, initiating a synchronous transmission task for the reusable KV Cache to start the transmission of the reusable KV Cache from the CPU to the GPU; and allocating the reusable KV Cache to the first user query.

From the above process, when a new user query is received, if there is a reusable KV Cache for this user query and the KV Cache is currently stored in the CPU, the KV Cache can be directly transmitted to the GPU so that the required KV Cache can be read from the GPU during the inference process, thereby improving the processing speed and efficiency of the user query.

In addition to allocating the reusable KV Cache, when there is a situation where KV Caches cannot be reused, the embodiment of the present disclosure further allocates a non-reusable KV Cache to the first user query, for example:
determining a non-reusable key-value cache of the first user query according to the token list, and storing the non-reusable KV Cache in the GPU; and
allocating the non-reusable KV Cache to the first user query.

The above process can further allocate the KV Cache to the user query. In combination with the aforementioned process of allocating the reusable KV Cache, the large model processing system first allocates the reusable KV Cache to the newly-received user query, and then allocates the non-reusable KV Cache to the newly-received user query when the newly-received user query cannot be satisfied, for use in the subsequent inference process.

After the corresponding KV Caches (including reusable and non-reusable KV Caches) are generated and allocated for the token list of the first user query, the reusable and non-reusable KV Caches may be used to perform inference on the first user query.

Further, in the method proposed in the embodiment of the present disclosure, when the inference for the first user query ends and the first KV Cache of the first user query meets the condition for transmission from the GPU to the CPU (i.e., evicting the first KV Cache), the CPU resource is allocated for the first KV Cache, and the asynchronous transmission task of the first KV Cache is initiated to start the transmission process of the first KV Cache from the GPU to the CPU.

Here, the first KV Cache includes a reusable KV Cache or a non-reusable KV Cache.

After initiating the asynchronous transfer task of the first KV Cache, the large model service system does not need to wait for the transmission process of the first KV Cache from the GPU to the CPU to finish, but can perform other operations. If it is found in the transmission process that the first KV Cache has been reused by other user queries (that is, the transmission process of the first KV Cache is stopped in the process of processing other user queries), the CPU resource may be recycled. Since the large model service system can perform other operations without waiting for the eviction process of the KV Cache to finish, the scheduling and transmission efficiency of the KV Cache is improved, thereby increasing the rate at which the large model service system processes new queries and improving the system throughput.

Further, if the first KV Cache is not reused by other user queries during the transmission process, that is, if the first KV Cache completes the transmission from the GPU to the CPU, the GPU resource for storing the first KV Cache may be recycled. The aforementioned process ensures the integrity of the eviction process of the KV Cache.

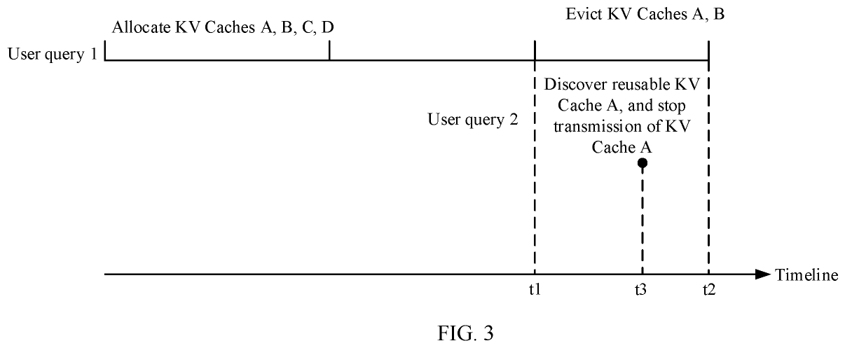

As can be seen, in the method for processing the user query proposed in the embodiment of the present disclosure, the allocation process and eviction process (i.e., transmission from the GPU to the CPU) of the KV Cache are correspondingly coupled. FIG. 3 is a schematic diagram of the allocation process and eviction process of KV Caches according to an embodiment of the present disclosure. As shown in FIG. 3, after receiving a user query 1, the large model service system generates and allocates four KV Caches for the user query 1, including KV Cache A, KV Cache B, KV Cache C and KV Cache D; and uses the four KV Caches generated and allocated to perform inference on the user query 1. After the inference is completed, KV Cache A and KV Cache B meet the eviction condition, and the eviction process for KV Cache A and KV Cache B is initiated at time t1. Without interruption, the eviction process will continue until time t2. After receiving a user query 2, the large model service system discovers at time t3 that KV Cache A can be reused by the user query 2. Here, time t3 is after time t1 and before time t2. That is to say, when it is discovered that KV Cache A can be reused by the user query 2, KV Cache A is in the transmission process from the GPU to the CPU. In this case, the transmission of KV Cache A may be stopped, and KV Cache A may be kept in the GPU and allocated to the user query 2. Since KV Cache B is not reused, the eviction process of KV Cache B is continued. After the eviction is completed, KV Cache B is stored in the CPU.

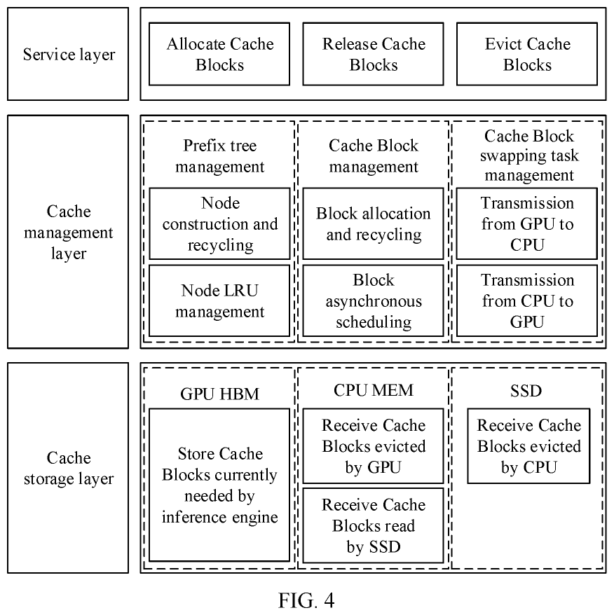

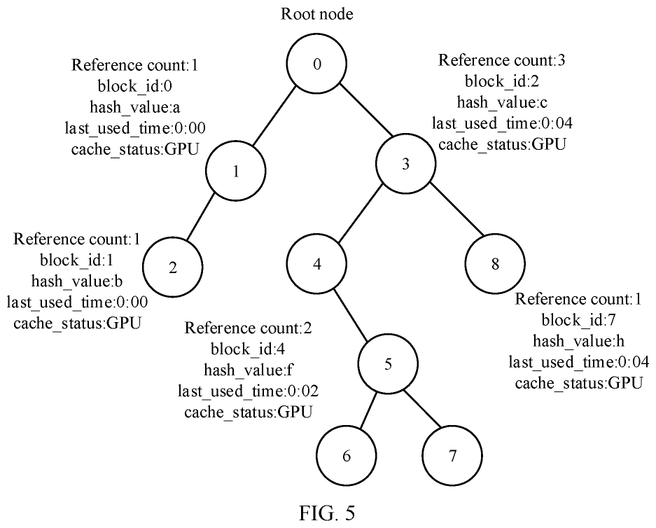

Based on the Paged Attention technology, in the embodiment of the present disclosure, the KV Cache may be logically represented in unit of Cache Block. One Cache Block contains a plurality of KV Caches, and one Cache Block typically corresponds to 64 tokens. FIG. 4 is a schematic diagram of the overall framework of the large model service system according to an embodiment of the present disclosure. As shown in FIG. 4, the overall framework includes a service layer, a Cache management layer and a Cache storage layer; where the service layer is used to allocate Cache Blocks, release Cache Blocks, and evict Cache Blocks.

The Cache management layer includes prefix tree management, Cache Block management, and Cache Block swapping task management. Here, the prefix tree management is used for construction and recycling of Nodes and Least Recently Used (LRU) management of Nodes; the Cache Block management is used for allocation and recycling of Cache Blocks and asynchronous scheduling of Cache Blocks; and the Cache Block swapping task management is used for transmission of Cache Blocks, such as transmission from GPU to CPU, or transmission from CPU to GPU.

The Cache storage layer mainly includes GPU HBM, CPU MEM, SSD and other storage media. Here, the GPU HBM is used to store Cache Blocks currently needed by the inference engine; the CPU MEM is used to receive Cache Blocks evicted by the GPU and Cache Blocks read by the SSD; and the SSD is used to receive Cache Blocks evicted by the CPU.

When the large model service system receives a user query, there is a need to allocate KV Cache storage resources for inference to the user query. The KV Cache is logically represented in unit of Cache Block, and one Cache Block typically represents 64 tokens. To manage the KV Cache, the prefix tree is used to construct Cache Block resources required for each query, and each node in the prefix tree corresponds to a Cache Block. Cache Blocks may come from different storage media, such as GPU or CPU.

In one example, the representation of the prefix tree is shown in FIG. 5.

The prefix tree consists of one root node and multiple leaf nodes, with each leaf node corresponding to a Cache Block. The representation of each leaf node is shown in Table 1:

TABLE 1

| Field | Meaning |
|---|---|
| node_id | Unique id of node |
| children | Child node |
| parent | Parent node |
| shared_count | Shared count of node by query being inferred |
| depth | Depth of node in prefix tree |
| block_id | Allocated block id |
| last_used_time | Last used time |
| hash_value | Hash value representing token ids |
| token_num | Number of token ids corresponding to current node |
| reverved_dec_block_ids | block ids allocated to decoder, in the format [block_id, |
| | block_id, . . . ], where only leaf nodes have values |
| has_in_gpu | Is Cache corresponding to current node in GPU? |
| is_cpu_leaf_node | Is current node a leaf node on CPU? |
| | Judgment criteria: there is no child node, and current node is on |
| | CPU |
| is_gpu_leaf_node | Is current node a leaf node on GPU? |
| | Judgment criteria: there is no child node on GPU (there may be |
| | child nodes on CPU), and current node is on GPU |
| cache_status | Indicate node status: |
| | GPU: represents being on GPU |
| | SWAP2CPU: represents being transmitted from GPU to CPU |
| | SWAP2GPU: represents being transmitted from CPU to GPU |
| | CPU: represents being on CPU |

The large model service system manages two resource pools: Node resource pool and Cache Block resource pool (called Block resource pool for short).

The Node resource pool stores idle node_ids and is managed using a list. When a new Node is created in the prefix tree, a node_id is retrieved from the Node resource pool. When a Node is recycled in the prefix tree, a node_id is added to the Node resource pool. The number of node_ids in the Node resource pool determines the maximum number of Cache Blocks in the system.

The Block resource pool stores idle block_ids and is managed using a heap. When a Cache Block needs to be allocated, a block_id is retrieved from the Block resource pool. When a Cache Block needs to be recycled, a block_id is added to the Block resource pool. Different media have their own separate Block resource pools.

The capacity of the Node resource pool is the sum of the capacities of the Block resource pools of different media.

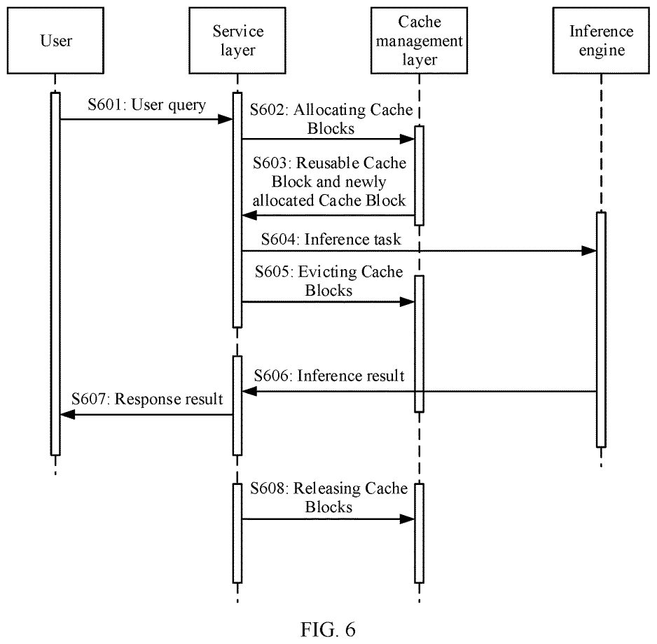

When the large model service system receives a query, the Cache management layer is responsible for allocating Cache Block resources. In this process, the reusable Cache Blocks and the Cache Blocks to be newly allocated from the resource pool will be determined. When the system finishes inference for a query, the system releases the used Cache Block and decrements the shared count of the Cache Block by 1, but does not recycle the Cache Block into the Block resource pool. When the remaining available Cache Blocks in the Block resource pool fall below the threshold, the eviction of Cache Blocks will be triggered. At this time, the LRU algorithm will be used to recycle Cache Blocks into the Block resource pool. Different media have their own separate LRU heaps, such as GPU LRU heap and CPU LRU heap. The timing diagram of this process is shown in FIG. 6 below, and mainly includes the following steps:
S601: a user sends a user query to the service layer.
S602: the service layer initiates a task of allocating Cache Blocks to the Cache management layer based on the user query.
S603: the Cache management layer determines a reusable Cache Block and a non-reusable Cache Block (i.e., a newly allocated Cache Block) and feeds them back to the service layer.
S604: the service layer determines an inference task based on the reusable Cache Block and the newly allocated Cache Block, and sends the inference task to the inference engine.
S605: when the Cache Blocks in the resource pool are insufficient, evicting Cache Blocks in the LRU heap.
S606: the inference engine processes and analyzes the inference task to obtain an inference result, and feeds the inference result back to the service layer.
S607: the service layer further processes the inference result, such as data organization and aggregation, to generate a response result for the user query, and feeds the response result back to the user.
S608: after completing the inference task, releasing the idle Cache Blocks to the corresponding LRU heap.

The asynchronous scheduling algorithm for Cache Blocks in the method for processing the user query proposed in the embodiment of the present disclosure will be described in detail below, including: allocating Cache Blocks, releasing Cache Blocks, and evicting Cache Blocks.

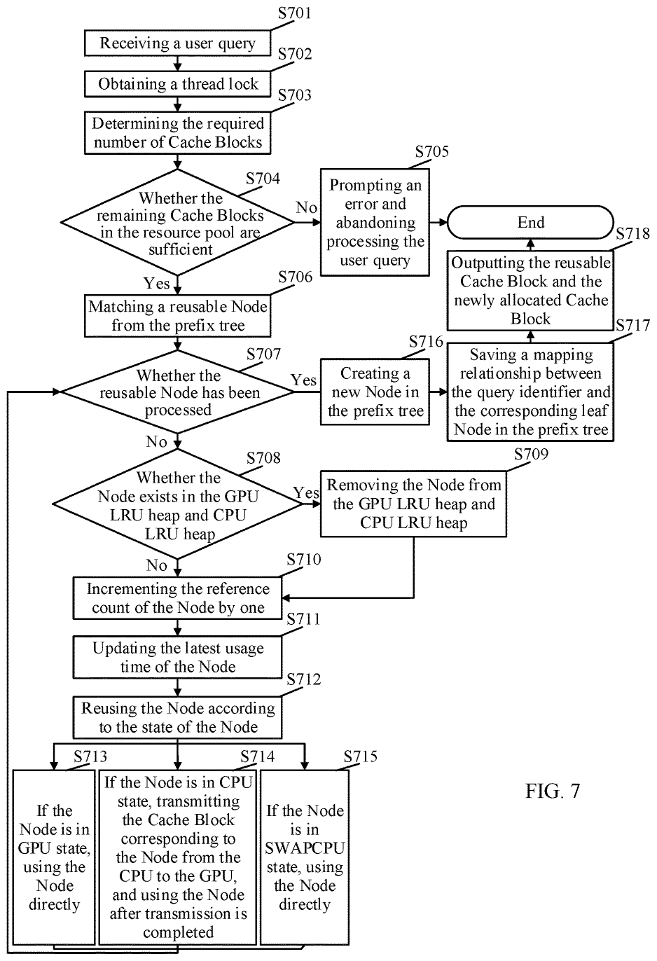

FIG. 7 is a schematic diagram of a process of allocating Cache Blocks according to an embodiment of the present disclosure. As shown in FIG. 7, the process includes the following steps:
S701: receiving a user query.
S702: obtaining a thread lock.
S703: determining the required number of Cache Blocks according to the user query.
S704: judging whether the remaining Cache Blocks in the GPU Cache Block resource pool are sufficient according to the required number of Cache Blocks. If the remaining Cache Blocks in the resource pool are insufficient, execute S705; if the Cache Blocks in the resource pool are sufficient, execute S706.
S705: if the remaining Cache Blocks in the resource pool are insufficient, prompting an error and abandoning processing the user query.
S706: if the remaining Cache Blocks in the resource pool are sufficient, matching a reusable Node from the prefix tree. In one example, the hash values calculated in units of 64 tokens in the Cache corresponding to the user query may be matched with the hash values of all Nodes in the prefix tree, to thereby determine the reusable Node.
S707: judging whether the reusable Node has been processed. If the reusable Node has not been processed, execute S708; if the reusable Node has been processed, execute S716.
S708: judging whether the Node exists in the GPU LRU heap and CPU LRU heap. If so, execute S709; if not, execute S710.
S709: when the Node exists in the GPU LRU heap and CPU LRU heap, removing the Node from the GPU LRU heap and CPU LRU heap. Then S710 is executed.
S710: incrementing the reference count of the Node by one.
S711: updating the latest usage time of the Node.
S712: determining the method of reusing the Node according to the state of the Node. The method of reusing the Node may include S713 to S715.
S713: if the state of the Node is GPU state, using the Node directly.
S714: if the state of the Node is CPU state, initiating a synchronization transmission task to transmit the Cache Block corresponding to the Node from the CPU to the GPU, and changing the state of the Node to SWAPGPU. After the synchronization transmission task is completed, the state of the Node is changed to GPU state, the Node is used, and the associated Cache Block identifier in the CPU is recycled to the CPU Cache Block resource pool.
S715: if the state of the Node is SWAPCPU, meaning that the Cache Block corresponding to the Node is being transmitted from the GPU to the CPU, then using the Node directly, and changing the state of the Node to GPU state, and simultaneously recycling the associated Cache Block in the CPU to the CPU Cache Block resource pool.
S716: after completing the processing of the reusable Node, creating a new Node in the prefix tree for a non-reusable Cache Block related to the user query, and allocating a GPU Cache Block and a corresponding identifier to the new Node.
S717: saving a mapping relationship between the identifier of the user query and the corresponding leaf Node in the prefix tree.
S718: outputting the reusable Cache Block and the newly allocated Cache Block.

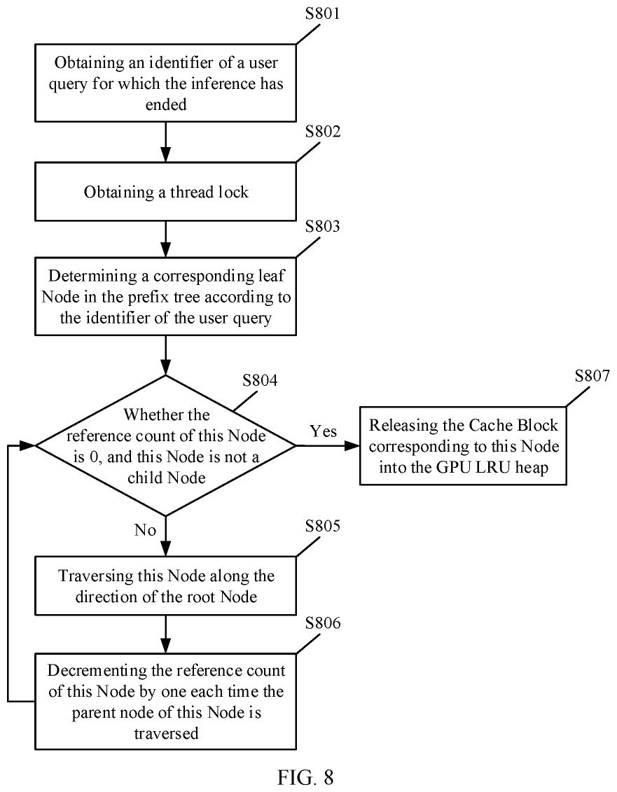

FIG. 8 is a schematic diagram of a process of releasing Cache Blocks according to an embodiment of the present disclosure. As shown in FIG. 8, the process includes the following steps:
S801: obtaining an identifier of a user query for which the inference has ended.
S802: obtaining a thread lock.
S803: determining a leaf Node corresponding to the identifier in the prefix tree according to the identifier of the user query.
S804: judging whether the reference count of this Node is 0 and that this Node is not a child Node. If not, execute S805; if yes, execute S807.
S805: traversing this Node along the direction of the root Node.
S806: decrementing the reference count of this Node by one each time the parent node of this Node is traversed.
S807: when the reference count of this Node is 0 and this Node is not a child Node, releasing the Cache Block corresponding to this Node into the GPU LRU heap.

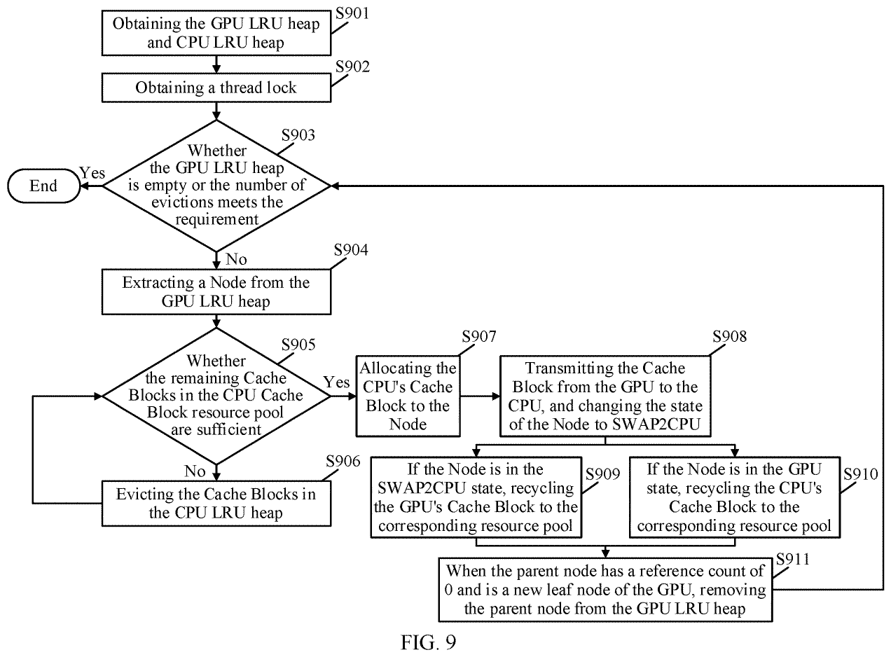

FIG. 9 is a schematic diagram of a process of evicting Cache Blocks according to an embodiment of the present disclosure. As shown in FIG. 9, the process includes the following steps:
S901: obtaining the GPU LRU heap and CPU LRU heap.
S902: obtaining a thread lock.
S903: judging whether the GPU LRU heap is empty or the number of evictions meets the requirement. If so, the eviction process ends; if not, S904 is executed.
S904: extracting a Node from the GPU LRU heap.
S905: judging whether the remaining Cache Blocks in the CPU Cache Block resource pool are sufficient. If so, execute S907; if not, execute S906.
S906: when the remaining Cache Blocks in the CPU Cache Block resource pool are insufficient, evicting the Cache Blocks in the CPU LRU heap. The eviction process is as follows:

A Node is extracted from the CPU LRU heap. If the CPU LRU heap is empty or the number of evictions meets the requirement, the eviction from the CPU LRU heap is stopped.

Further, for the extracted Node, the Node is removed from the prefix tree, the node_id is recycled to the Node resource pool, and the CPU Cache Block associated with the Node is recycled to the CPU Cache Block resource pool.

Finally, when the parent node has a reference count of 0 and is a new leaf node on the CPU, the parent node is removed from the CPU LRU heap.
S907: when the remaining Cache Blocks in the CPU Cache Block resource pool are sufficient, allocating the CPU's Cache Block to the Node extracted in S904.
S908: initiating an asynchronous transmission task of the Cache Block from the GPU to the CPU to transmit the Cache Block from the GPU to the CPU, and correspondingly changing the state of the Node corresponding to the Cache Block to SWAP2CPU. After the asynchronous transmission task is completed, the resources to be recycled are determined based on the state of the Node. The determining method may include S909 to S910.
S909: if the Node is in the SWAP2CPU state, then recycling the GPU's Cache Block to the GPU Cache Block resource pool, changing the state of the Node to the CPU state, and setting the Node's Cache Block to the CPU's Cache Block.
S910: if the Node is in the GPU state, meaning that the GPU's Cache Block is reused by a new user query during the asynchronous transmission task, then recycling the CPU's Cache Block directly.
S911: when the parent node has a reference count of 0 and is a new leaf node of the GPU, removing the parent node from the GPU LRU heap, and returning to S903.

In some implementations, during the asynchronous scheduling process of Cache Blocks described above, multiple Cache Blocks in contiguous storage regions can be transmitted at once when transmitting Cache Blocks (including: transmitting Cache Blocks from the GPU to the CPU, or transmitting Cache Blocks from the CPU to the GPU). For example, if multiple Cache Blocks are stored in contiguous locations before transmission and are to be placed in contiguous storage locations after transmission, then the multiple Cache Blocks can be copied directly in large chunks without needing to copy each Cache Block separately. For example, in the copy operation from CPU to GPU with GPU block_id [1,2,3,5,7] and CPU block_id [3,4,5,10,11], since the storage regions of GPU block_id [1,2,3] are contiguous and the storage regions of CPU block_id [3,4,5] are also contiguous, these two regions can be copied directly in large chunks without needing to be copied separately for each block_id. This approach helps improve the bandwidth utilization of Cache Block transmission.

In addition, to ensure that the block_id used by the same user query is contiguous, the Cache Blocks may be managed using a data structure heap, so that the recycling of block_id and the allocation of block_id are ordered and contiguous as possible.

When using the service system based on context caching, the response generation time and data throughput with a large number of reusable Cache Blocks are usually better than those of the inference system not based on context caching. However, aggressively increasing the maximum batch size of the service to further improve throughput will lead to a deterioration in the latency of whole sentence processing. This situation indicates that the service system faces a key challenge in high-throughput scenarios: it is difficult to fully translate the benefits of context caching acceleration into increased throughput while maintaining effective control of latency.

In some implementations, the method for processing the user query proposed in the embodiment of the present disclosure further includes:
determining an average acceleration ratio of context caching; and
determining a maximum batch size for processing the user query according to a reference batch size and the average acceleration ratio of context caching.

In the embodiment of the present disclosure, the reference batch size may be determined in the performance benchmark test of the service system without using reusable key-value caches. By gradually increasing the batch size of user queries, the key performance indicators such as CPU utilization, memory usage and response time of the service system are monitored. When the performance indicator of the service system reach a significant inflection point, for example, the CPU utilization approaches the system limit, the memory usage causes frequent memory swapping operations, or the response time exceeds the acceptable threshold for service, the batch size at this point is the reference batch size.

In some implementations, determining the average acceleration ratio of context caching includes:

determining the average acceleration ratio of context caching based on a proportional relationship between the number of reusable key-value caches and the number of key-value caches required by the first user query.

In one example, the hit rate of reusable key-value caches for the first user query is determined based on the proportional relationship between the number of reusable key-value caches and the number of key-value caches required by the first user query. Specifically, the higher the hit rate of reusable key-value caches, the greater the proportion of the required data that can be directly obtained from the cache during the query inference process, that is, the more the reusable cache content. Since a large number of queries can be directly satisfied by reusable key-value caches, there is no need to trigger the underlying complex data processing or calculation process, and the overall amount of computation undertaken by the service system will be significantly reduced.

For example, when a user first raises a question, the large model will perform inference calculation on the question and may store intermediate results or key information in the cache during the inference process. If the user raises a new question again later and the new question contains part or all of the content of the previous question, the large model can directly retrieve the relevant results that were previously calculated for the old question from the cache when processing the new question, based on the high cache hit rate. In this way, the large model does not need to repeat the computational parts involved in the old problem.

In the embodiment of the present disclosure, the average acceleration ratio of context caching can be determined based on the proportional relationship between reusable key-value caches and total key-value caches. The larger the proportional relationship is, the more the reusable key-value caches, and the greater the average acceleration ratio of context caching.

Using the above method, the control index of the service system throughput is determined according to the proportion of the reusable key-value caches in the total key-value caches, providing a data foundation for the control of the maximum throughput of the service system, and thereby improving the throughput of the large model service system.

Further, the maximum batch size may be determined using the following formula:

$$max\_batch \_size = batch\_size + reserved\_batch \_size * d \%$$

In this formula, batch_size is the reference batch size to ensure the user experience, reserved_batch_size is the batch size that can be newly added, d % is the average acceleration ratio of context caching, and max_batch_size is the maximum batch size.

The above method is deeply bound to the acceleration ratio of context caching, so as to increase the service throughput to the greatest extent under the premise of providing users with consistent experience, and adapt to the performance requirements in different service scenarios. Furthermore, this method can reduce problems such as increased latency in processing user queries and abnormal response results caused by excessive parameter adjustment in pursuit of throughput.

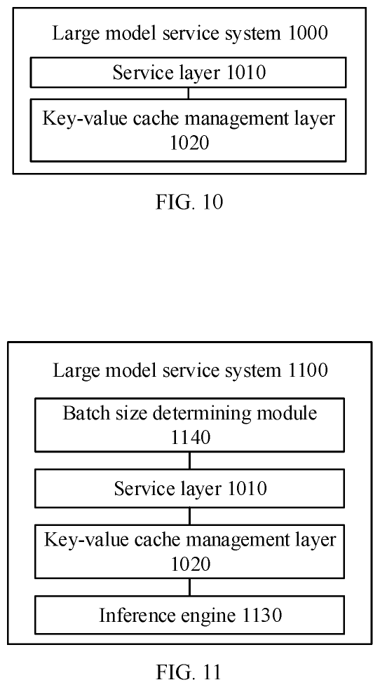

An embodiment of the present disclosure further provides a large model service system. FIG. 10 is a structural schematic diagram of a large model service system 1000 according to an embodiment of the present disclosure, including:
a service layer 1010 configured to: receive a first user query; and perform word segmentation on the first user query to obtain a token list corresponding to the first user query; and
a key-value cache management layer 1020 configured to: determine a reusable key-value cache of the first user query according to the token list; and when the reusable key-value cache is in a process of transmission from a graphics processing unit to a central processing unit, stop the transmission of the reusable key-value cache, and allocate the reusable key-value cache to the first user query.

In some implementations, the key-value cache management layer 1020 is further configured to: when the reusable key-value cache is stored in the central processing unit, initiate a synchronous transmission task of the reusable key-value cache to start transmission of the reusable key-value cache from the central processing unit to the graphics processing unit; and allocate the reusable key-value cache to the first user query.

In some implementations, the key-value cache management layer 1020 is further configured to: determine a non-reusable key-value cache of the first user query according to the token list, and store the non-reusablze key-value cache in the graphics processing unit; and allocate the non-reusable key-value cache to the first user query.

As shown in FIG. 11, in some implementations, the system further includes an inference engine 1130 configured to infer the first user query by using the reusable key-value cache and the non-reusable key-value cache.

In some implementations, the key-value cache management layer 1020 is further configured to: when a first key-value cache of the first user query meets a condition for transmission from the graphics processing unit to the central processing unit, allocate a central processing unit resource to the first key-value cache, and initiate an asynchronous transmission task of the first key-value cache to start a process of transmitting the first key-value cache from the graphics processing unit to the central processing unit; and when the first key-value cache is reused by another user query, recycle the central processing unit resource.

In some implementations, the key-value cache management layer 1020 is further configured to: when the first key-value cache is not reused by another user query, recycle a graphics processing unit resource for storing the first key-value cache.

In some implementations, the first key-value cache of the first user query includes at least one of:
the reusable key-value cache of the first user query; or
the non-reusable key-value cache of the first user query.

In some implementations, the reusable key-value cache is logically represented in unit of cache block, and each cache block contains a plurality of reusable key-value caches.

In some implementations, the reusable key-value cache is transmitted from the graphics processing unit to the central processing unit by:
determining a plurality of cache blocks stored in a plurality of contiguous storage regions of the graphics processing unit, where the plurality of cache blocks contain a plurality of reusable key-value caches; and
transmitting the plurality of cache blocks to the central processing unit, and storing the plurality of cache blocks in a plurality of contiguous storage regions of the central processing unit.

In some implementations, the reusable key-value cache is transmitted from the central processing unit to the graphics processing unit by:
determining a plurality of cache blocks stored in a plurality of contiguous storage regions of the central processing unit, where the plurality of cache blocks contain a plurality of reusable key-value caches; and
transmitting the plurality of cache blocks to the graphics processing unit, and storing the plurality of cache blocks in a plurality of contiguous storage regions of the graphics processing unit.

As shown in FIG. 11, the system may further include a batch size determining module 1140 configured to: determine an average acceleration ratio of context caching; and determine a maximum batch size for processing the user query according to a reference batch size and the average acceleration ratio of context caching.

In some implementations, the batch size determining module 1140 is configured to determine the average acceleration ratio of context caching based on a proportional relationship between the number of reusable key-value caches and the number of key-value caches required by the first user query.

For the description of specific functions and examples of the modules and sub-modules of the apparatus of the embodiment of the present disclosure, reference may be made to the relevant description of the corresponding steps in the above-mentioned method embodiments, and details are not repeated here.

In the technical solution of the present disclosure, the acquisition, storage and application of the user's personal information involved are in compliance with relevant laws and regulations, and do not violate public order and good customs.

According to the embodiments of the present disclosure, the present disclosure also provides an electronic device, a readable storage medium and a computer program product.

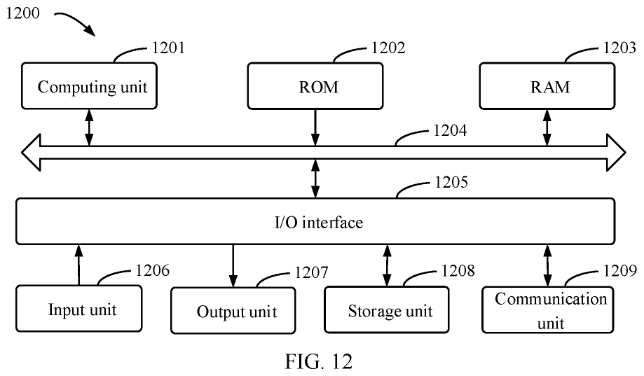

FIG. 12 shows a schematic block diagram of an exemplary electronic device 1200 that may be used to implement the embodiments of the present disclosure. The electronic device is intended to represent various forms of digital computers, such as a laptop, a desktop, a workstation, a personal digital assistant, a server, a blade server, a mainframe computer, and other suitable computers. The electronic device may also represent various forms of mobile devices, such as a personal digital assistant, a cellular phone, a smart phone, a wearable device and other similar computing devices. The components shown herein, their connections and relationships, and their functions are merely examples, and are not intended to limit the implementation of the present disclosure described and/or required herein.

As shown in FIG. 12, the device 1200 includes a computing unit 1201 that may perform various appropriate actions and processes according to a computer program stored in a Read-Only Memory (ROM) 1202 or a computer program loaded from a storage unit 1208 into a Random Access Memory (RAM) 1203. Various programs and data required for an operation of device 1200 may also be stored in the RAM 1203. The computing unit 1201, the ROM 1202 and the RAM 1203 are connected to each other through a bus 1204. The input/output (I/O) interface 1205 is also connected to the bus 1204.

A plurality of components in the device 1200 are connected to the I/O interface 1205, and include an input unit 1206 such as a keyboard, a mouse, or the like; an output unit 1207 such as various types of displays, speakers, or the like; the storage unit 1208 such as a magnetic disk, an optical disk, or the like; and a communication unit 1209 such as a network card, a modem, a wireless communication transceiver, or the like. The communication unit 1209 allows the device 1200 to exchange data with other devices through a computer network such as the Internet and/or various telecommunication networks.

The computing unit 1201 may be various general-purpose and/or special-purpose processing components with processing and computing capabilities. Some examples of the computing unit 1201 include, but are not limited to, a Central Processing Unit (CPU), a Graphics Processing Unit (GPU), various dedicated Artificial Intelligence (AI) computing chips, various computing units that run machine learning model algorithms, a Digital Signal Processor (DSP), and any appropriate processors, controllers, microcontrollers, or the like. The computing unit 1201 performs various methods and processing described above, such as the method for processing the user query. For example, in some implementations, the method for processing the user query may be implemented as a computer software program tangibly contained in a computer-readable medium, such as the storage unit 1208. In some implementations, a part or all of the computer program may be loaded and/or installed on the device 1200 via the ROM 1202 and/or the communication unit 1209. When the computer program is loaded into the RAM 1203 and executed by the computing unit 1201, one or more steps of the method for processing the user query described above may be performed. Alternatively, in other implementations, the computing unit 1201 may be configured to perform the method for processing the user query by any other suitable means (e.g., by means of firmware).

Various implementations of the system and technologies described above herein may be implemented in a digital electronic circuit system, an integrated circuit system, a Field Programmable Gate Array (FPGA), an Application Specific Integrated Circuit (ASIC), an Application Specific Standard Product (ASSP), a System on Chip (SOC), a Complex Programmable Logic Device (CPLD), a computer hardware, firmware, software, and/or a combination thereof. These various implementations may be implemented in one or more computer programs, and the one or more computer programs may be executed and/or interpreted on a programmable system including at least one programmable processor. The programmable processor may be a special-purpose or general-purpose programmable processor, may receive data and instructions from a storage system, at least one input device, and at least one output device, and transmit the data and the instructions to the storage system, the at least one input device, and the at least one output device.

The program code for implementing the method of the present disclosure may be written in any combination of one or more programming languages. The program code may be provided to a processor or controller of a general-purpose computer, a special-purpose computer or other programmable data processing devices, which enables the program code, when executed by the processor or controller, to cause the function/operation specified in the flowchart and/or block diagram to be implemented. The program code may be completely executed on a machine, partially executed on the machine, partially executed on the machine as a separate software package and partially executed on a remote machine, or completely executed on the remote machine or a server.

In the context of the present disclosure, a machine-readable medium may be a tangible medium, which may contain or store a procedure for use by or in connection with an instruction execution system, device or apparatus. The machine-readable medium may be a machine-readable signal medium or a machine-readable storage medium. The machine-readable medium may include, but is not limited to, an electronic, magnetic, optical, electromagnetic, infrared or semiconductor system, device or apparatus, or any suitable combination thereof. More specific examples of the machine-readable storage medium may include electrical connections based on one or more lines, a portable computer disk, a hard disk, a Random Access Memory (RAM), a Read-Only Memory (ROM), an Erasable Programmable Read-Only Memory (EPROM or a flash memory), an optical fiber, a portable Compact Disc Read-Only Memory (CD-ROM), an optical storage device, a magnetic storage device, or any suitable combination thereof.

In order to provide interaction with a user, the system and technologies described herein may be implemented on a computer that has: a display apparatus (e.g., a cathode ray tube (CRT) or a Liquid Crystal Display (LCD) monitor) for displaying to the user; and a keyboard and a pointing device (e.g., a mouse or a trackball) through which the user may provide input to the computer. Other types of devices may also be used to provide interaction with the user. For example, feedback provided to the user may be any form of sensory feedback (e.g., visual feedback, auditory feedback, or tactile feedback), and the input from the user may be received in any form (including an acoustic input, a voice input, or a tactile input).

The system and technologies described herein may be implemented in a computing system (which serves as, for example, a data server) including a back-end component, or in a computing system (which serves as, for example, an application server) including a middleware, or in a computing system including a front-end component (e.g., a user computer with a graphical user interface or web browser through which the user may interact with the implementation of the system and technologies described herein), or in a computing system including any combination of the back-end component, the middleware component, or the front-end component. The components of the system may be connected to each other through any form or kind of digital data communication (e.g., a communication network). Examples of the communication network include a Local Area Network (LAN), a Wide Area Network (WAN), and the Internet.

A computer system may include a client and a server. The client and server are generally far away from each other and usually interact with each other through a communication network. A relationship between the client and the server is generated by computer programs running on corresponding computers and having a client-server relationship with each other. The server may be a cloud server, a distributed system server, or a blockchain server.

It should be understood that, the steps may be reordered, added or removed by using the various forms of the flows described above. For example, the steps recorded in the present disclosure can be performed in parallel, in sequence, or in different orders, as long as a desired result of the technical scheme disclosed in the present disclosure can be realized, which is not limited herein.

The foregoing specific implementations do not constitute a limitation on the protection scope of the present disclosure. Those having ordinary skill in the art should understand that, various modifications, combinations, sub-combinations and substitutions may be made according to a design requirement and other factors. Any modification, equivalent replacement, improvement or the like made within the principle of the present disclosure shall be included in the protection scope of the present disclosure.

What is claimed is:

1. A method for processing a user query, comprising:
receiving a first user query;
performing word segmentation on the first user query to obtain a token list corresponding to the first user query;
determining a reusable key-value cache of the first user query according to the token list; and
in a case where the reusable key-value cache is in a process of transmission from a graphics processing unit to a central processing unit, stopping the transmission of the reusable key-value cache, and allocating the reusable key-value cache to the first user query.

2. The method of claim 1, further comprising:
in a case where the reusable key-value cache is stored in the central processing unit, initiating a synchronous transmission task of the reusable key-value cache to start transmission of the reusable key-value cache from the central processing unit to the graphics processing unit; and
allocating the reusable key-value cache to the first user query.

3. The method of claim 1, further comprising:
determining a non-reusable key-value cache of the first user query according to the token list, and storing the non-reusable key-value cache in the graphics processing unit; and
allocating the non-reusable key-value cache to the first user query.

4. The method of claim 3, further comprising:
inferring the first user query by using the reusable key-value cache and the non-reusable key-value cache.

5. The method of claim 4, further comprising:
in a case where a first key-value cache of the first user query meets a condition for transmission from the graphics processing unit to the central processing unit, allocating a central processing unit resource to the first key-value cache, and initiating an asynchronous transmission task of the first key-value cache to start a process of transmitting the first key-value cache from the graphics processing unit to the central processing unit; and
in a case where the first key-value cache is reused by another user query, recycling the central processing unit resource.

6. The method of claim 5, further comprising:
in a case where the first key-value cache is not reused by another user query, recycling a graphics processing unit resource for storing the first key-value cache.

7. The method of claim 5, wherein the first key-value cache of the first user query comprises at least one of:
the reusable key-value cache of the first user query; or
the non-reusable key-value cache of the first user query.

8. The method of claim 5, wherein the reusable key-value cache is logically represented in unit of cache block, and each cache block contains a plurality of reusable key-value caches.

9. The method of claim 8, wherein the reusable key-value cache is transmitted from the graphics processing unit to the central processing unit by:
determining a plurality of cache blocks stored in a plurality of contiguous storage regions of the graphics processing unit, wherein the plurality of cache blocks contain a plurality of reusable key-value caches; and
transmitting the plurality of cache blocks to the central processing unit, and storing the plurality of cache blocks in a plurality of contiguous storage regions of the central processing unit.

10. The method of claim 8, wherein the reusable key-value cache is transmitted from the central processing unit to the graphics processing unit by:
determining a plurality of cache blocks stored in a plurality of contiguous storage regions of the central processing unit, wherein the plurality of cache blocks contain a plurality of reusable key-value caches; and
transmitting the plurality of cache blocks to the graphics processing unit, and storing the plurality of cache blocks in a plurality of contiguous storage regions of the graphics processing unit.

11. The method of claim 1, further comprising:
determining an average acceleration ratio of context caching; and
determining a maximum batch size for processing the user query according to a reference batch size and the average acceleration ratio of context caching.

12. The method of claim 11, wherein the determining an average acceleration ratio of context caching, comprises:
determining the average acceleration ratio of context caching based on a proportional relationship between the number of reusable key-value caches and the number of key-value caches required by the first user query.

13. An electronic device, comprising:
at least one processor; and
a memory connected in communication with the at least one processor;
wherein the memory stores an instruction executable by the at least one processor, and the instruction, when executed by the at least one processor, enables the at least one processor to execute operations comprising:
receiving a first user query;
performing word segmentation on the first user query to obtain a token list corresponding to the first user query;
determining a reusable key-value cache of the first user query according to the token list; and
in a case where the reusable key-value cache is in a process of transmission from a graphics processing unit to a central processing unit, stopping the transmission of the reusable key-value cache, and allocating the reusable key-value cache to the first user query.

14. The electronic device of claim 13, wherein the operations further comprise:
in a case where the reusable key-value cache is stored in the central processing unit, initiating a synchronous transmission task of the reusable key-value cache to start transmission of the reusable key-value cache from the central processing unit to the graphics processing unit; and
allocating the reusable key-value cache to the first user query.

15. The electronic device of claim 13, wherein the operations further comprise:
determining a non-reusable key-value cache of the first user query according to the token list, and storing the non-reusable key-value cache in the graphics processing unit; and
allocating the non-reusable key-value cache to the first user query.

16. The electronic device of claim 15, wherein the operations further comprise:
inferring the first user query by using the reusable key-value cache and the non-reusable key-value cache.

17. A non-transitory computer-readable storage medium storing a computer instruction thereon, wherein the computer instruction is used to cause a computer to execute operations comprising:
receiving a first user query;
performing word segmentation on the first user query to obtain a token list corresponding to the first user query;
determining a reusable key-value cache of the first user query according to the token list; and
in a case where the reusable key-value cache is in a process of transmission from a graphics processing unit to a central processing unit, stopping the transmission of the reusable key-value cache, and allocating the reusable key-value cache to the first user query.

18. The non-transitory computer-readable storage medium of claim 17, wherein the operations further comprise:
in a case where the reusable key-value cache is stored in the central processing unit, initiating a synchronous transmission task of the reusable key-value cache to start transmission of the reusable key-value cache from the central processing unit to the graphics processing unit; and
allocating the reusable key-value cache to the first user query.

19. The non-transitory computer-readable storage medium of claim 17, wherein the operations further comprise:
determining a non-reusable key-value cache of the first user query according to the token list, and storing the non-reusable key-value cache in the graphics processing unit; and
allocating the non-reusable key-value cache to the first user query.

20. The non-transitory computer-readable storage medium of claim 19, wherein the operations further comprise:
inferring the first user query by using the reusable key-value cache and the non-reusable key-value cache.
